(19) United States
(12) Patent Application Publication
(10) Pub. No.: US 2014/0100694 A1
(43) Pub. Date: Apr. 10, 2014

(54) SYSTEM AND METHOD FOR CAMERA-BASED AUTO-ALIGNMENT

(71) Applicant: Beckman Coulter, Inc., Brea, CA (US)

(72) Inventors: Stefan Rueckl, Garching bei Muenchen (DE); Sebastian Streibl, Muenchen (DE); Manuel Sickert, Puergen (DE)

(73) Assignee: Beckman Coulter, Inc., Brea, CA (US)

(21) Appl. No.: 14/046,829

(22) Filed: Oct. 4, 2013

Related U.S. Application Data
(60) Provisional application No. 61/710,612, filed on Oct. 5, 2012.
(60) Provisional application No. 61/745,252, filed on Dec. 21, 2012.
(60) Provisional application No. 61/772,971, filed on Mar. 5, 2013.

(51) Int. Cl. B25J 9/16

(52) U.S. Cl. CPC B25J 9/1692
USPC 700/254

(57) ABSTRACT

A camera-based auto-alignment process can include gripping a first calibration tool by a gripper unit of a robotic arm. Images of the first calibration tool can be captured by a camera coupled to the gripper unit. The gripper unit and camera unit can be aligned on two roughly parallel axes. The images can be analyzed to calibrate the axis of view of the camera with the gripper axis, providing an XY calibration of the robotic arm. The gripper unit can be calibrated on a Z-axis using optical calibration with landmarks provided on a second calibration tool, and/or by moving the gripper unit towards the work surface until it makes contact with the work surface and stops. Once calibrated, the camera can be used to identify one or more landmarks at known locations on the work surface to align the robotic arm with the work surface.

### CROSS-REFERENCE TO RELATED APPLICATIONS

This application claims priority to U.S. Provisional Patent Application No. 61/710,612, filed on Oct. 5, 2012, titled “SYSTEM AND METHOD FOR AUTO-ALIGNMENT,” by Stefan Rueckl; to U.S. Provisional Patent Application No. 61/745,252, filed on Dec. 21, 2012, titled “SYSTEM AND METHOD FOR AUTO-ALIGNMENT,” by Stefan Rueckl, et al.; and to U.S. Provisional Patent Application No. 61/772,971, filed on Mar. 5, 2013, titled “SYSTEM AND METHOD FOR AUTO-ALIGNMENT,” by Stefan Rueckl, et al., each of which is herein incorporated by reference in its entirety for all purposes. This application is related to U.S. patent application Ser. No. ______ (application No. Not Yet Assigned), filed on Oct. 4, 2013, titled “SYSTEM AND METHOD FOR LASER-BASED AUTO ALIGNMENT,” by Stephen Otts, which is herein incorporated by reference in its entirety for all purposes.

### BACKGROUND

When a Laboratory Automation System (LAS) is installed at a customer site, a service technician aligns elements of the system, e.g. the frame, XY-gantry for the robotic arm, and the drawers on the work surface, to enable the robotic arm to precisely grip and transfer sample tubes from one position to another position. Typically, alignment of the robot arm to the working space was done manually. Manual alignment is a slow and costly process, particularly on a complex LAS which may include several robotic arms which must each be separately aligned. Additionally, manual alignment has the potential to introduce human error into each alignment. Auto-alignment processes allow for fewer service technicians to install and align more LAS in less time and with fewer risks of incorrect alignment due to human error.

In a typical LAS, each robotic arm is fixed to a gantry over a work surface, which can include, e.g., test tubes in racks that can be moved to different positions or tools on the work surface. For example, moving a test tube from a distribution rack to a centrifuge adapter. Gripping movement needs to be precise to avoid various problems. For example, if the robotic arm cannot grip a tube, or if it successfully grips a selected tube, but destroys the tube due to a misalignment. Conventional manual alignment can include various steps, such as manually positioning the gripper arm to several different positions on the work surface, either by hand or using an external drive motor. Additionally, the robotic arms need to be separately aligned for racks or drawers on the work surface. This procedure can take many hours to a day per robotic arm for manual alignment by a service technician.

Embodiments of the present invention address these and other problems.

### SUMMARY

Disclosed herein are an auto-alignment process and associated technical arrangements to calibrate and/or align a robotic arm with gripper unit within a Laboratory Automation System (LAS), in accordance with an embodiment.

In a camera-based alignment system, a camera can be attached to an XYZ-robot at the position of the gripper unit to allow the robotic arm to acquire images of the work surface below the gripper position. Alignment of the camera and the robotic arm can be performed when the camera is installed, by aligning the optical axis of the camera with the axis of the robotic arm during installation. However, accurately installing the camera, and ensuring that the camera does not change positions, can be cost prohibitive in complex systems involving multiple robotic arms. Accordingly, an auto-alignment procedure utilizing the camera can reduce production costs associated with precisely attaching the camera to the robotic arm, as well as provide a ready method of realigning the camera-robotic arm system should the position of the camera shift or otherwise become misaligned.

In accordance with an embodiment, a camera-based auto-alignment process can include gripping a first calibration tool by a gripper unit of a robotic arm. Images of the first calibration tool can be captured by a camera coupled to the gripper unit. The gripper unit and camera unit can be aligned on two roughly parallel axes. The images can be analyzed to calibrate the axis of view of the camera with the gripper axis, providing an XY calibration of the robotic arm. The gripper unit can be calibrated on a Z-axis using optical calibration with landmarks provided on a second calibration tool, and/or by moving the gripper unit towards the work surface until it makes contact with the work surface and stops. Once calibrated, the camera can be used to identify one or more landmarks at known locations on the work surface to align the robotic arm with the work surface.

### BRIEF DESCRIPTION OF THE DRAWINGS

FIG. 1 shows a camera-gripper arrangement for an XYZ-robot, in accordance with an embodiment of the invention.

FIG. 2 shows a plurality of landmark designs for use in camera-based auto-alignment, in accordance with an embodiment of the invention t.

FIG. 3 shows an X-Y calibration tool, in accordance with an embodiment of the invention.

FIG. 4 shows a Z calibration tool, in accordance with an embodiment of the invention.

FIG. 5 shows an example of a laboratory automation system (LAS), in accordance with an embodiment of the invention.

FIG. 6 shows a camera unit and gripper unit attached to a Z axis housing, in accordance with an embodiment of the invention.

FIG. 7 shows a method of calibrating an XYZ-robot, in accordance with an embodiment of the invention.

FIG. 8 shows examples of common radial distortions.

FIG. 9 shows a method of X-Y calibration, in accordance with an embodiment of the invention.

FIG. 10 shows a projection of a path of the X-Y calibration tool during calibration, in accordance with an embodiment of the invention.

FIG. 11 shows ellipses produced by imaging properties of an image capture device during calibration, in accordance with an embodiment of the invention.

FIG. 12 shows triangulation of a landmark to determine a height of the image capture device, in accordance with an embodiment of the invention.

FIG. 13 shows a method of Z calibration, in accordance with an embodiment of the invention.

FIG. 14 shows a system for determining precision of a camera-based auto-alignment system, in accordance with an embodiment of the invention.

FIG. 15 shows a block diagram of an auto-alignment system, in accordance with an embodiment of the invention.

FIG. 16 shows a block diagram of a computer apparatus, in accordance with an embodiment of the invention.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

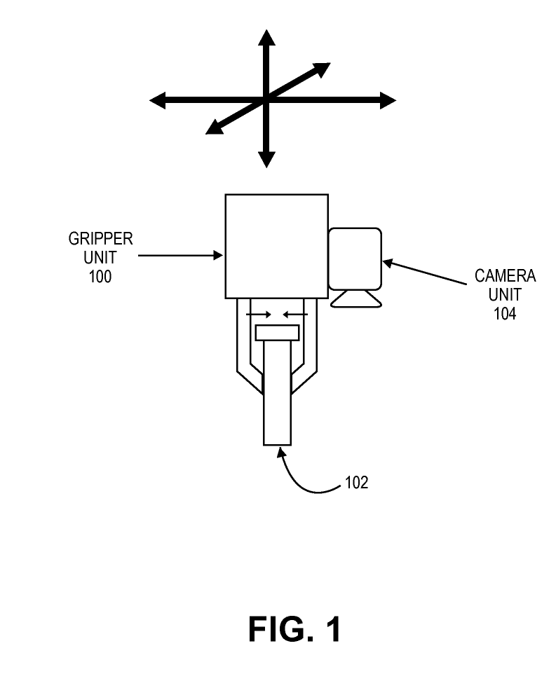

FIG. 1 shows a camera-gripper arrangement for an XYZ-robot, in accordance with an embodiment. In accordance with an embodiment, a method for auto-alignment using a camera as an optical measurement tool is disclosed. A robotic arm can include a gripper unit 100 that is operable to grip, pick-up, and move objects on a work surface in a laboratory automation system (LAS). A camera, or other image capture device, can be coupled to the gripper unit such that images and/or video captured by the camera can be used to identify elements in the LAS and align the robotic arm with the LAS. In some embodiments, the camera is coupled to the gripper unit such that the camera is maintained at a fixed height while the gripper unit can be moved along a Z-axis. During alignment of the robotic arm, the camera and gripper unit can be calibrated with one or more calibration tools. The calibration process is used to establish a relationship between the camera coordinate system (expressed in pixels) and the robot coordinate system (expressed in steps or encoder counts). Calibration can also account for optical imperfections in the camera that can result in distortions that, uncorrected, could lead to misalignment. Once the camera is calibrated, the camera can be used to identify landmarks located at known positions on the work surface. This aligns the robotic arm with the LAS.

In accordance with an embodiment, the gripper unit 100 can grip elements 102 in the LAS. These elements can include test tubes, calibration tools, and other objects. The elements 102 are gripped using the gripper unit on a first axis. Due to an offset between a camera unit 104 and the gripper unit 100, images can be acquired by the camera unit 104 on a second axis. Typical cameras and assemblies are too large to be integrated into the gripper assembly or into a grippable tool. As such, a camera unit can be coupled adjacent to the gripper unit, resulting in a mechanical offset between the first axis and second axis. Since the camera does not interfere with the gripper unit during normal operation, the camera can stay fixed to the gripper unit, enabling auto-alignment to be performed further as needed. The images can be analyzed to determine an offset between the second axis and the first axis and to calibrate the camera coordinate system to the robot coordinate system. The offset can account for any angular misalignment between the first axis and the second axis. A conversion ratio between motor steps and pixels can be determined by positioning the camera over a landmark and moving the robotic arm a predetermined number of steps in the X and Y directions. The conversion ratio can be determined based on the change in apparent position of the landmark. The offset and the conversion ratio can be used to calibrate the gripper in an X-Y plane. The gripper can then be calibrated on a Z-axis using a second calibration tool. Optionally, one or more landmarks on one or more elements on the work surface, e.g. an input area, can be identified to verify the precision of the calibration of the gripper. Once calibration is complete, the camera unit can be used to identify one or more landmarks at known locations on the work surface, to align the robotic arm to the LAS.

In accordance with an embodiment, calibrating the gripper on a Z-axis can include optically calibrating the gripper using landmarks provided on the second calibration tool, for example by triangulating the distance to a fixed landmark from the camera. Additionally, or alternatively, the gripper can be calibrated on the Z-axis physically, by moving the gripper toward the second calibration tool along the Z-axis until the gripper reaches a contact on the second calibration tool.

As described above, visual landmarks can be used in the calibration and alignment process of the robotic arm with the LAS. For example, the calibration tools can include landmarks that the camera unit can recognize, and landmarks on the work surface can be used to align the robotic arm to the LAS. Landmarks can include contrasting geometrical shapes positioned at known locations on the work surface. Landmarks can also be positioned on calibration tools, used to calibrate the camera and gripper unit.

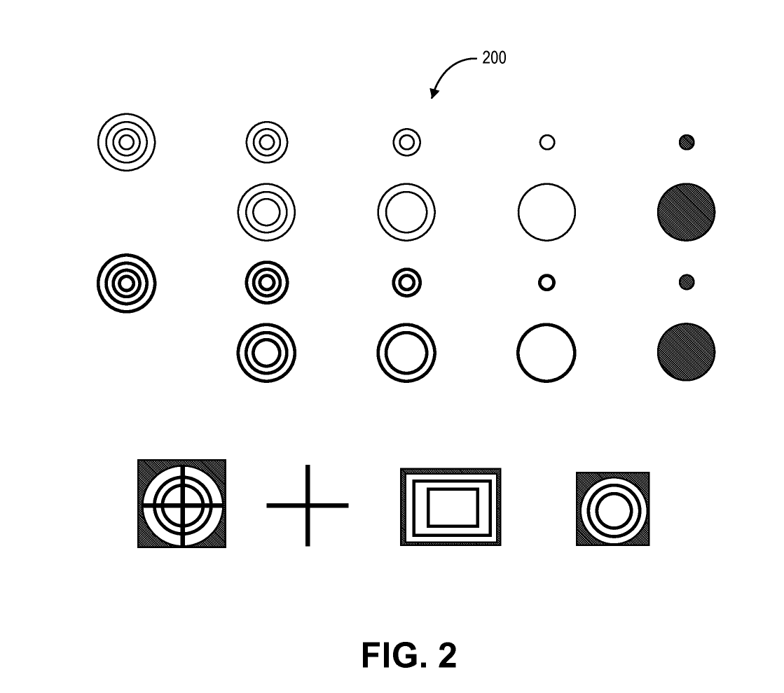

FIG. 2 shows examples of different landmark designs 200. In some embodiments, the landmarks can be printed on a substrate, such as an adhesive paper or vinyl, that can be applied to the work surface. In some embodiments, the landmarks can be mechanically, chemically, or otherwise etched into the work surface and filled with a contrasting filler, such as paint or epoxy. Alternatively, the contrast could also be achieved by etching components that have been anodized or otherwise coated. This provides permanent landmarks that will not shift or move on the work surface.

Ideally, a landmark can be chosen that is easy to create, has an easily identifiable midpoint, and has a low mis-identification risk. For example, a linear landmark, such as a cross or rectangle, can be more difficult to identify reliably than a circular landmark. Additionally, scratches on the work surface may be more easily mistaken for a linear landmark than a circular landmark. Landmarks comprising a plurality of concentric circles are easy to identify, are less likely than linear landmarks to be mis-identified, and the mid-point can be determined by the algebraic average of all identified circle mid-points. Although circular landmarks are typically used herein, any contrasting shape, including but not limited to those shown in FIG. 2, can be used with embodiments of the present invention. When the camera unit captures an image of the work surface, the image can be processed using a pattern recognition process to determine whether a landmark is present in the image. The pattern recognition process can determine whether the landmark is present and, if so, identify a midpoint of the landmark. The midpoint can be expressed as a position in the camera coordinate system in pixels.

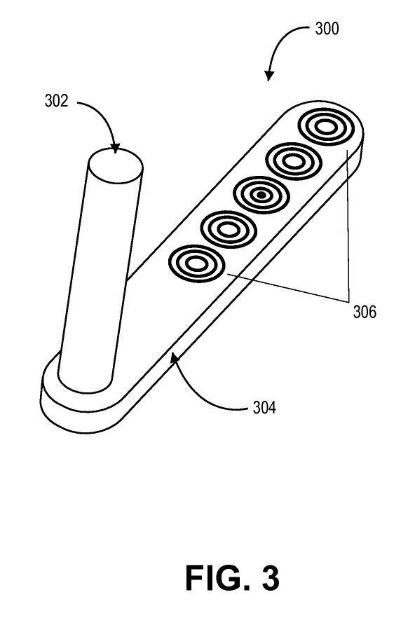

FIG. 3 shows an X-Y calibration tool, in accordance with an embodiment of the invention. The X-Y calibration tool can be used to calibrate the gripper unit in the X-Y plane. As used herein, the X-Y plane can refer to a plane that is parallel to the work surface. As described above, a camera can be coupled to a gripper unit of a robotic arm, resulting in an offset between the camera axis and the gripper unit axis. This offset may vary from installation to installation as a result of mechanical tolerances built into the robotic arm and the camera, as well as variations in installation hardware and other factors. As such, the offset is not known prior to installation and can be determined during alignment and calibration of the robotic arm to the LAS.

As shown in FIG. 3, X-Y calibration tool 300 can include a grippable portion 302 and a substantially horizontal portion 304. When the grippable portion 302 is gripped by the gripper unit, the substantially horizontal portion 304 can be visible to the camera. The substantially horizontal portion includes a plurality of landmarks 306 that can be detected by the camera and used to measure the offset between the camera axis and the axis of the robotic gripper. In some embodiments, calibration can be performed where at least two markers on the X-Y calibration tool can be detected. The X-Y calibration tool shown in FIG. 3 has five landmarks 306, however more or fewer landmarks could also be used. The landmarks are located at known distances along the tool, where the distances are known from the center of each landmark to the center of the grippable portion 302. The dimensions of the X-Y calibration tool can be selected based on the LAS to which the robotic arm is deployed. The diameter of the grippable portion 302 can be chosen based on a diameter of objects the robot is likely to pick up regularly. For example, for a robot which regularly grips test tubes, the diameter of the cylinder can be chosen to approximate diameter of a test tube. The length of the horizontal portion 304 can be selected to be greater than the offset between the gripper axis and the camera axis, ensuring that the horizontal portion 304 is visible to the camera during calibration. The flow of the X-Y calibration process is described in detail below, in accordance with an embodiment.

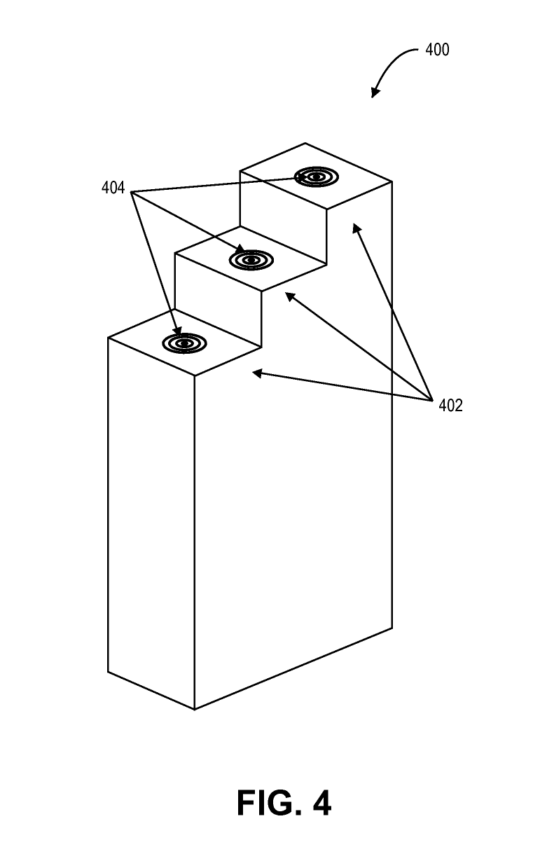

FIG. 4 shows a Z-calibration tool 400, in accordance with an embodiment of the invention. The Z-calibration tool can be used to calibrate the gripper unit along the Z-axis. As used herein, the Z-axis can refer to an axis that is orthogonal to the work surface. The Z-calibration tool can include a plurality of levels 402 at known heights. Each level can include a landmark 404 that can be identified by the camera. In some embodiments, labels, such as bar codes can be used to assign unique identification numbers to landmark on the Z-calibration tool 400. The Z-calibration tool can either be attached to the work surface at a pre-defined position by the service technician during installation or can be permanently integrated into the work surface. In accordance with an embodiment, Z-calibration can be performed after X-Y calibration.

In accordance with an embodiment, the robotic arm can include a pressure sensor and can be configured to stop once resistance is met. This is typically used as a safety feature, to prevent the robotic arm from causing damage to itself, the work surface or objects on the work surface. Using the pressure sensor as an automatic stop, the robotic arm can be positioned over a first landmark on the Z-calibration tool, and lowered until the gripper unit makes contact with the first landmark. When contact is made, the pressure sensor stops the robotic arm. When the arm is stopped, the position of the motor on the Z-axis can be recorded. In accordance with an embodiment, the motors used to drive the robotic arm along each axis can be brushed DC motors or stepper motors. The position of the motor on the Z-axis can be recorded in encoder counts or steps. This process can be repeated for each landmark on the Z-calibration tool. Once each position has been recorded, the distance between each level can be determined in encoder counts or steps. As described further below, triangulation can be used to determine a height of each level of the Z-calibration tool (e.g., in steps per pixel). The flow of the Z-axis calibration process, in accordance with an embodiment, is further described below.

In some embodiments, a single calibration tool that combines features of the X-Y calibration tool and the Z-calibration tool can be used. For example, a combined calibration tool could resemble the X-Y calibration tool as described above, that has been modified such that each landmark is at a different level.

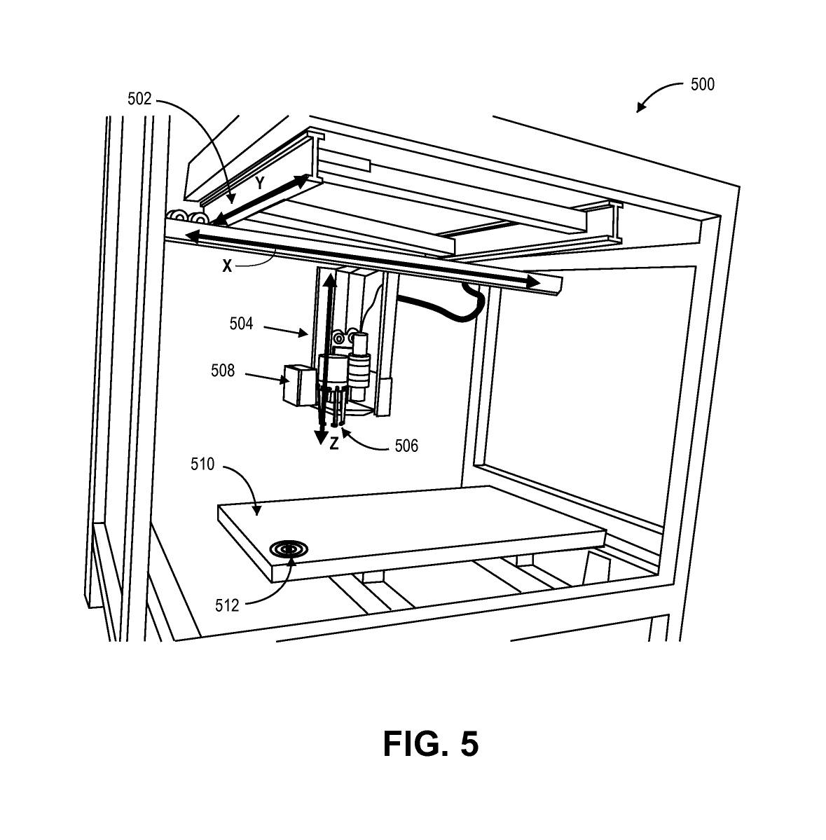

FIG. 5 shows an example of a laboratory automation system (LAS), in accordance with an embodiment of the invention. As shown in FIG. 5, LAS 500 can include a frame with an X-Y gantry 502 to which a Z-axis 504 has been attached. A robotic arm including a gripper unit 506 and a camera unit 508 can each be coupled to the Z-axis 504. As described above, the X-Y gantry is operable to move the robotic arm and gripper unit above a work surface 510 in the X-Y plane, and the Z-axis is operable to move the robotic arm and gripper unit up and down relative to the work surface 510. In accordance with an embodiment, each axis can be moved along tracks using one or more electric motors. In some embodiments, the motors can be brushed DC motors or stepper motors with a known motor resolution in steps per millimeter. One or more controllers, such as a microcontroller, processor, or other controller, can be used to control the motors associated with each axis and position the robotic arm in three dimensional space over the work surface. To align the robotic arm with the work surface, the work surface can include one or more landmarks 512 at known positions. The camera unit can be calibrated, which enables the camera coordinate system in pixels to be converted to the robot coordinate system in encoder counts or steps. Additionally, the calibration process can correct for small angular misalignments between the camera axis and the gripper unit axis, as well as optical defects in the camera, such as lens distortions. Additionally, the robotic arm can be automatically aligned with the work surface using the one or more landmarks 512, enabling the robotic arm to perform functions where precision is important, such as picking up and repositioning objects on the work surface. Some embodiments can utilize other types of robots, e.g. a Selective Compliant Assembly Robot Arm (SCARA) may be used.

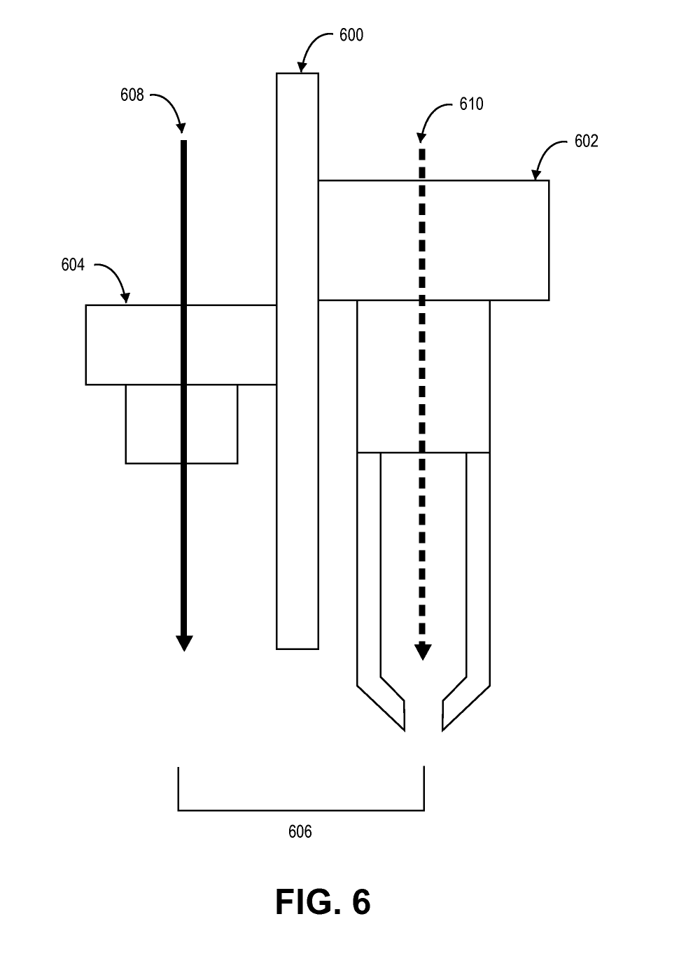

FIG. 6 shows a camera unit and gripper unit attached to a Z axis housing, in accordance with an embodiment of the invention. As shown in FIG. 6, Z-axis housing 600 can serve as a mounting point for gripper unit 602 and camera unit 604. This results in an offset 606, between the optical camera axis 608 and the mechanical gripper axis 610. Ideally, during installation an effort is made to maintain a substantially parallel alignment between the optical axis of the camera 608 and the mechanical gripper axis 610. However, careful and accurate alignment of the axes can be costly, including increased manufacturing, component, and installation costs. These costs can be compounded if the system comes out of alignment, resulting in costly realignment procedures. Additionally, a complex LAS may include a large number of robotic arms, further compounding potential costs.

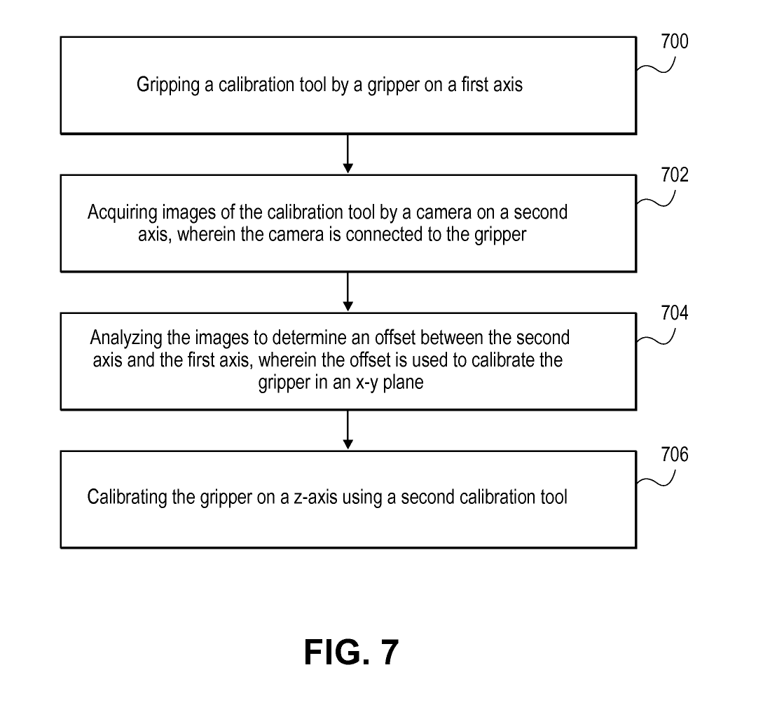

In accordance with an embodiment, an auto-alignment process provides an efficient, repeatable way of correctly installing robotic arms in an LAS, and provides a fast maintenance procedure should any of the robotic arms come out of alignment during use. FIG. 7 shows a method of camera-based auto-alignment, in accordance with an embodiment of the invention. At 700, an X-Y calibration tool can be gripped by the gripper unit on a first axis. The X-Y calibration tool can be picked up at a known location on the work surface, or a technician can manually instruct the gripper unit to grip the X-Y calibration tool. At 702, images of the X-Y calibration tool can be captured by a camera, on a second axis, coupled to the gripper unit. Based on the captured images, a distance corresponding to an offset between the camera axis and the gripper axis can be determined. As this offset is subject to mechanical tolerances it cannot be predefined through programming. During this process, the distance can be determined without the use of further sensors or measurement tools. At 704, a Z calibration can be performed between the camera and the Z-axis to enable a precise measurement of the height of the landmarks in the motor units. In some embodiments, lens distortion can also be calculated and corrected during X-Y calibration or Z calibration. In some embodiments, lens distortion can be corrected as a separate step during the alignment process. Once the above-mentioned alignment steps have been successfully performed the system is ready for use. In some embodiments, after calibrating the camera unit and correcting for lens distortion, the camera unit can be used to identify one or more landmarks on a work surface of the LAS to align the robotic arm in the LAS.

Complex LAS can include many robotic arms each having its own camera. Accordingly, less expensive cameras can be utilized to reduce the fixed costs of a given LAS. However, less expensive cameras typically suffer from greater lens distortion effects than more expensive cameras. These distortions can be accounted for and corrected during the alignment process.

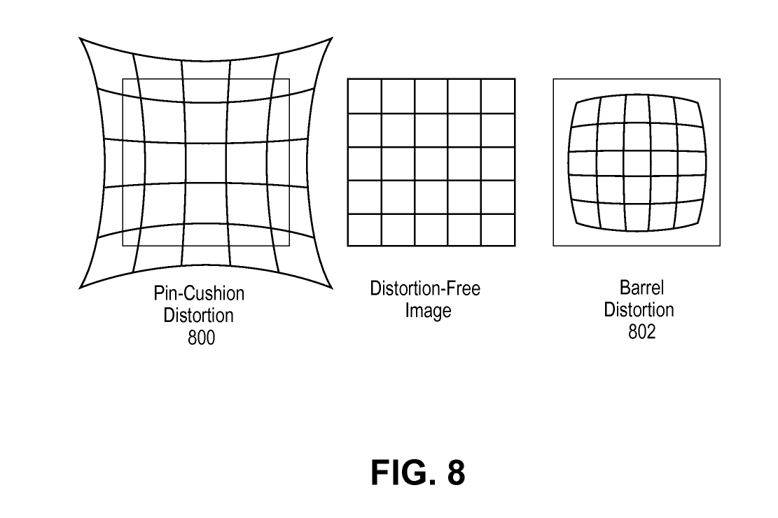

FIG. 8 shows examples of common radial distortions. The geometric properties of a lens can create certain distortions when images are recorded. There are two basic types of distortion. One is a radial distortion, also known as a pin-cushion 800 or barrel distortion 802. This is caused by the spherical form of the lens and the fact that the light passing through the center of the lens and hitting the chip is hardly refracted at all, whereas light passing through the edge of the lens is subject to a greater flexion and refraction effect. The second kind of distortion is a tangential distortion that is created by an angle between the lens and camera chip.

Radial distortion tends to be the more significant factor when using relatively high-quality lenses or cameras. The radial distortion can be represented as a series of polynomials:

\hat{x}=x*(1+α₁r²+α₂r⁴+ . . . )

ŷy*(1+α₁r²+α₂r⁴+ . . . ) (11)

where (\hat{x}, ŷ) is a distortion-corrected point corresponding to (x, y), α₁, α₂, . . . are the coefficients that describe the radial distortion, and r is the Euclidean distance of point (x, y) from the mid-point of the image, which in this case corresponds to point (0.0).

A calibration process can be performed to determine the coefficients. For the purposes of calibration it is assumed that α₁ sufficiently describes the radial distortion, and higher order effects can be ignored. Another model used to describe distortion is the Fitzgibbon division model:

$$\hat{x} = \frac{x}{1 + {α}_{1} {r}^{2}} \\ \hat{y} = \frac{y}{1 + {α}_{1} {r}^{2}} \qquad ( 12 )$$

When dealing with small α₁, the model is almost identical to the results of the series of polynomials for one factor. The equation (12) used in Fitzgibbon's division model can be reworked to form the following equation:

$$s * x = s * ( \begin{matrix}\hat{x} \\ \hat{y} \\ 1\end{matrix} ) = ( \begin{matrix}x \\ y \\ 1\end{matrix} ) + {α}_{1} * ( \begin{matrix}0 \\ 0 \\ {r}^{2}\end{matrix} ) \qquad ( 13 )$$

In this case, s describes a scaling factor and \hat{x} corresponds to distortion-corrected point (x,y).

The assumption that point x lies on line l=(l₁ l₂ l₃)^{τ} can be used to show lines can be formed on the segments on the circle as a result of the radial distortion:

l^{τ}p=0,

or

l₁x+l₂y+l₃(1+α₁*r²)=0 (14)

If this equation is then applied to the form of the circle equation

(x−xₘ)²+(y−yₘ)²=R² (15)

it follows that

$${( x + \frac{{l}_{1}}{2 * {α}_{1} * {l}_{3}} )}^{2} + {( y + \frac{{l}_{2}}{2 * {α}_{1} * {l}_{3}} )}^{2} = {( \frac{{l}_{1}}{2 * {α}_{1} * {l}_{3}} )}^{2} + {( \frac{{l}_{2}}{2 * {α}_{1} * {l}_{3}} )}^{2} - \frac{1}{{α}_{1}} \qquad ( 16 )$$

Thus, the following holds true for xₘ, yₘ, R:

$${x}_{m} = - \frac{{l}_{1}}{2 * {α}_{1} * {l}_{3}} , \\ {y}_{m} = - \frac{{l}_{2}}{2 * {α}_{1} * {l}_{3}} , \\ {R}^{2} = {x}_{m}^{2} + {y}_{m}^{2} - \frac{1}{{α}_{1}} \qquad ( 17 )$$

This property can be used to determine coefficient α₁. In accordance with an embodiment, a detected landmark is shifted to the edge of the image and then moved along that edge by moving one of the axes of the robot. The mid-point position of the landmark can be recorded during this process. Since only one of the robot's axes was moved, all of the measured mid-points lie along a line that joins them together. However, this is not the case due to the distortion described above. Next, a circle function is fitted to the measured mid-points. The equation (7) can then be applied to this function to determine distortion parameter α₁ as follows:

$${α}_{1} = \frac{1}{{x}_{m}^{2} + {y}_{m}^{2} + {R}^{2}} \qquad ( 18 )$$

where (xₘ,yₘ) is the midpoint of the circle and R the radius.

This process can then be repeated at all four corners of the image, thereby determining the coefficients measured in this manner.

Next, a transformation mask can be determined to ensure computationally-effective image transformation. In doing so, a matrix is generated using the dimensions of the image. Each element (i,j) of the matrix corresponds to a pixel from the original image and contains corrected position (î,ĵ) of that pixel. This mask is then used to correct each pixel in the image as soon as the image is recorded. Image processing libraries, such as the open source library OpenCV, include methods implemented for this purpose, and can be used to correct images as they are captured by the camera.

In some embodiments, a periodically repeating pattern landmark, such as a chess or checker board pattern, can be used to account for and correct lens distortion. In accordance with an embodiment, the periodically repeating pattern landmark can be printed on or mounted to a tool which can be gripped by the robot. In accordance with an embodiment, this tool can be similar to the X-Y calibration tool shown in FIG. 3, but featuring a periodically repeating pattern landmark or landmarks, such as a checkerboard, rather than circular landmarks. This enables the robot to rotate the periodically repeating pattern through the field of view of the camera, while also enabling the periodically repeating pattern to be moved closer to or farther away from the camera.

In accordance with an embodiment, periodically repeating pattern landmarks can also be printed on or mounted to a step-like tool, such as the Z-calibration tool shown in FIG. 4. In this case the robot and thus the camera moves independently from the pattern, and the robot can be moved such that the pattern is visible in a plurality of different positions within the field of view of the camera.

In accordance with an embodiment, features of the periodically repeating pattern landmark (e.g. edges of the chessboard pattern, single fields and the number of fields), as viewed through the camera, can be determined. Since the geometrical properties of the landmark are known to the system, the coordinates of these features can be compared to the known/expected position of the features using a fitting algorithm. Such fitting algorithms are available from OpenCV, the Camera Calibration Toolbox for Matlab®, DLR CalLab and CalDe—The DLR Camera Calibration Toolbox, and other similar software libraries. The fitting algorithm can then be used to estimate the intrinsic and extrinsic parameters of the computer vision system. The intrinsic and extrinsic parameters can be used to determine the distortion coefficients for the camera-lens combination in use. Using multiple pictures with the periodically repeating pattern landmark or landmarks in different positions, improves the accuracy of the distortion coefficients determined by the algorithm.

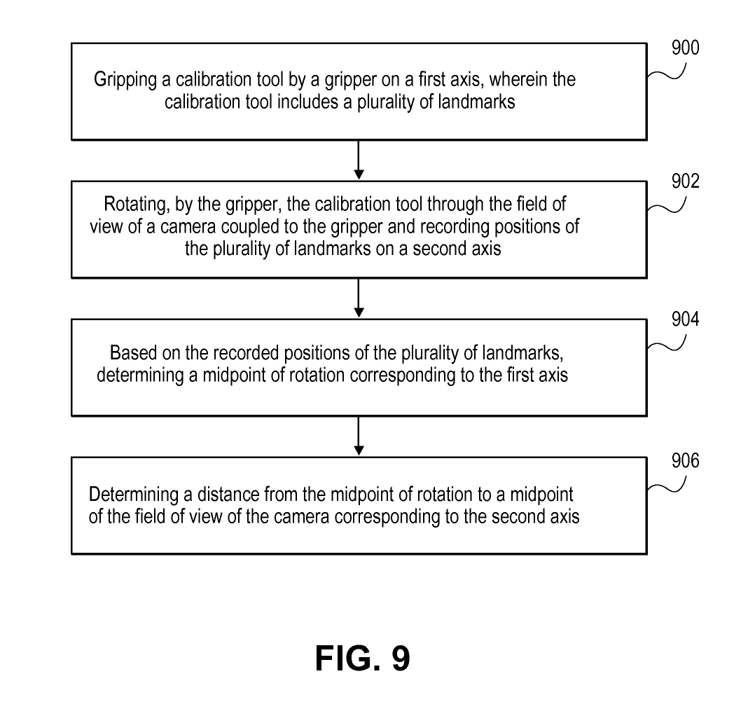

FIG. 9 shows a method of X-Y calibration, in accordance with an embodiment of the invention. In some embodiments, after lens distortion has been corrected, the X-Y calibration tool can be used to determine the offset between the camera axis and gripper unit axis and calibrate the camera. The X-Y calibration tool described above can be brought into the robot's area of operation to determine the X and Y distances between the camera axis and the gripper axis. Once the X-Y calibration process has been started, the user (e.g. a service technician) can be prompted to position the robot above the tool. The robot can then move to the gripping height and the user can have one more opportunity to adjust the position of the robot. At 900, the X-Y calibration tool can be gripped by the gripper unit of the robotic arm and the current X-Y position of the robot can be recorded. Next, the robot can move to an open area of the work surface and lower the tool to a designated or predetermined height for the calibration process. At 902, the gripper unit can rotate the X-Y calibration tool in rough increments until at least two of the landmarks on the tool have been successfully detected in images captured by the camera unit. Next, the tool is rotated in small increments until the furthermost landmarks can no longer be detected. The tool is then rotated once through the camera's entire field of view and the position of the landmarks on the tool are recorded in equal intervals. As the X-Y calibration tool is rotated through the camera's field of view, the camera can take a plurality of images at a programmed interval to capture the arc of the calibration tool, and the plurality of landmarks etched thereon. At 904, based on the recorded positions of the landmarks, a midpoint of rotation corresponding to the first axis can be determined. Since the landmarks are all moved along a circular path around the gripping robot's axis during the rotation, the mid-points of the circular paths can be determined in order to determine the offset between the first axis and the second axis. At 906, a distance in pixels can be determined using the offset from the first axis to the second axis. However, due to mechanical tolerances, the camera axis and the gripper unit axis may not be aligned parallel to one another. As such, rather than recording the circular path of the calibration tool, the observed path of the calibration tool is an ellipse.

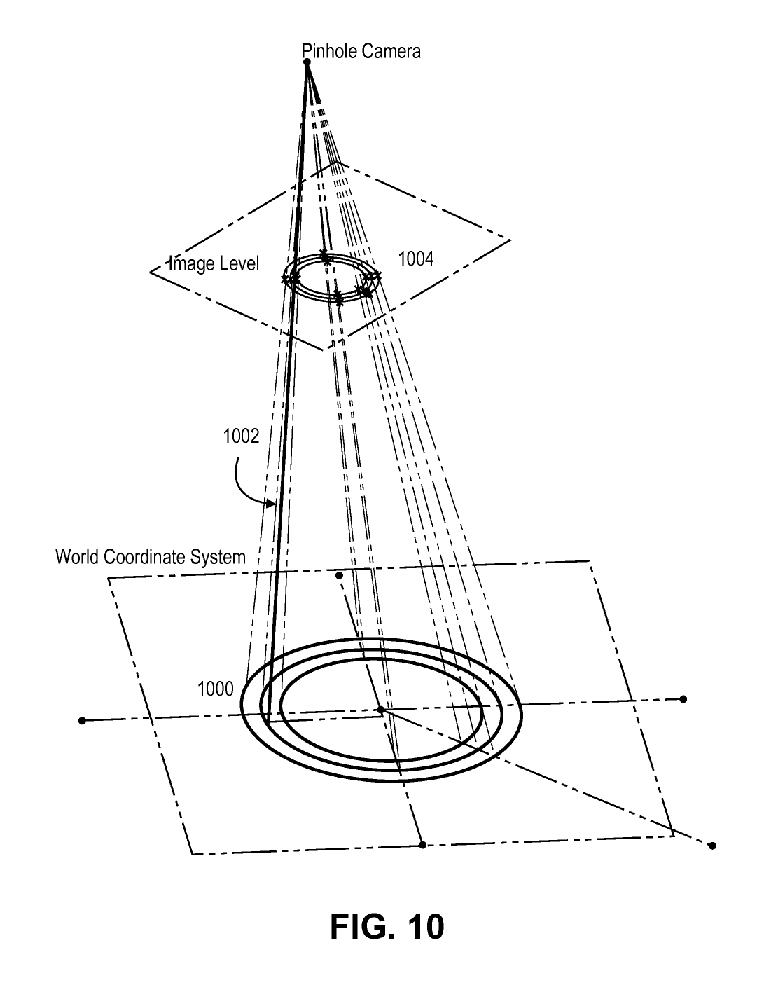

FIG. 10 shows a projection of a path of the X-Y calibration tool during calibration, in accordance with an embodiment of the invention. As described above, due to a combination of lens effects and the tilting and the offset of the camera axis relative to the gripper axis, the circular paths of the landmarks are recorded as conic sections, such as ellipses. As shown in FIG. 10, 1000 indicates the circles in the world coordinate system, 1002 indicates the optical axis of the camera, and 1004 indicates the projected circles in the camera system in the form of ellipses.

The following shows this projection in mathematical form:

The following intrinsic imaging matrix K can be assumed for the imaging properties of the camera:

$$K = [ \begin{matrix}f & 0 & {u}_{0} \\ 0 & f & {v}_{0} \\ 0 & 0 & 1\end{matrix} ] \qquad ( 19 )$$

where f is the focal length and point P=(u₀, v₀) describes the mid-point of the image. Point X=[X, Y, Z] is then mapped to point \tilde{x}=[u, v, w] as follows:

$$λ \tilde{x} = K [ \begin{matrix}R & T ] X ,\end{matrix} \\ with \\ R = [ \begin{matrix}{R}_{11} & {R}_{21} & {R}_{31} \\ {R}_{12} & {R}_{22} & {R}_{32} \\ {R}_{13} & {R}_{23} & {R}_{33}\end{matrix} ] , \\ T = [ \begin{matrix}{T}_{X} \\ {T}_{Y} \\ {T}_{Z}\end{matrix} ] \qquad ( 20 )$$

where K is the matrix of intrinsic camera properties described above, [R T] is the extrinsic camera matrix where R describes the rotation and T the translation of the camera coordinate system relative to the world coordinate system, and λ is a scaling factor not equal to zero.

If the mid-point of the circle is assumed to be [X_{C}, Y_{C},0], each point X in the circle would have to satisfy the following equation:

X^{T}CX=0 (21)

where C is the matrix that defines the circle:

$$C = [ \begin{matrix}1 & 0 & - {X}_{C} \\ 0 & 1 & - {Y}_{C} \\ - {X}_{C} & - {Y}_{C} & {X}_{C}^{2} + {Y}_{C}^{2} - {R}^{2}\end{matrix} ] \qquad ( 22 )$$

This circle is then depicted on ellipse E as follows:

λE=H^{-T}CH⁻¹

with

H=K[R₁R₂T] (23)

where R₁ and R₂ are the first two columns in rotation matrix R. The ellipse can now be described as follows:

$$E = [ \begin{matrix}A & B / 2 & D / 2 f \\ B / 2 & C & E / 2 f \\ D / 2 f & E / 2 f & E / {f}^{2}\end{matrix} ] \qquad ( 24 )$$

or as a function of x and y:

0=Ax²+Bxy+Cy²+Dx+Ey+F (25)

This is a general depiction of a conic where A=1 can be assumed without losing the universality:

0=x²+Bxy+Cy²+Dx+Ey+F (26)

The following conditions guarantee an ellipse (and thus exclude parabola and hyperbolas):

$${B}^{2} - 4 C < 0 , \\ \frac{{D}^{2}}{4} + \frac{{E}^{2}}{4 C} - F > 0 \qquad ( 27 )$$

In accordance with an embodiment, the previously measured point can be used to place ellipses along the trajectories of the circle. To do so, the method of the smallest error square can be used. This task can be solved using a numeric analysis and data processing library, such as ALGLIB. Alternative numerical analysis methods could also be used. To do so, the function from equation (15) can be transferred to a fitting algorithm. Moreover, the algorithm can receive initial values that can be used to start the iteration. These values are determined by using five-point combinations in equation (15) and then solving the equation system. This process is repeated with a few possible point combinations in order to then average the calculated coefficients. These values are then used as the initial values for the fitting algorithm, which uses an iterative process to determine the best solution in regard to the smallest error square.

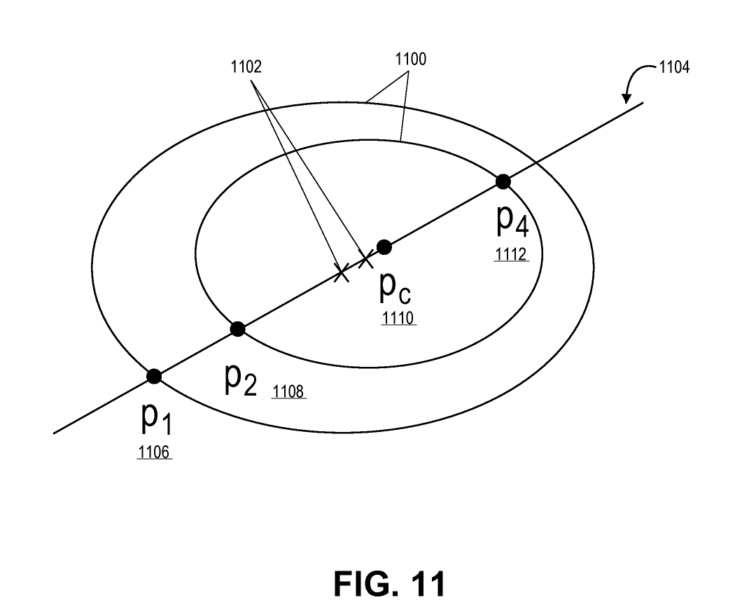

FIG. 11 shows ellipses produced by imaging properties of an image capture device during calibration, in accordance with an embodiment of the invention. The midpoints 1102 of each of the ellipses 1100 determined as described above with respect to FIG. 10 are dispersed along a straight line 1104. The projected mid-point of the circle is now located on a line that conjoins the mid-points of the ellipses. The projected mid-point of the circle, which provides the offset distances in the X and Y directions, can be determined using the following method which uses a ratio of radii that is retained by the projection to determine the mid-point of the circle:

Ratio of the radii of two circles before the projection:

$${c}_{r} = \frac{2 {R}_{2}}{{R}_{1} + {R}_{2}} \qquad ( 28 )$$

Ratio cᵣ now corresponds to the ratio of the segments produced by points of intersection p₁, p₂, p₄ 1106, 1108, 1112 where the line conjoining the midpoints of the ellipse and the ellipse intersect:

$${c}_{r} = \frac{d ( {p}_{1} , {p}_{c} ) d ( {p}_{2} , {p}_{4} )}{d ( {p}_{1} , {p}_{4} ) d ( {p}_{2} , {p}_{c} )} \\ with \\ d ( {p}_{i} {p}_{j} ) = \sqrt{{( {p}_{ix} - {p}_{jx} )}^{2} + {( {p}_{iy} - {p}_{jy} )}^{2}} \qquad ( 29 )$$

This equation can then be solved using the distance of circle amid-point p_{c}, p_{c}^{p}^{_{c}} 1110 to one of the points of intersection:

$$d ( {p}_{2} , {p}_{c} ) = \frac{d ( {p}_{2} , {p}_{1} ) d ( {p}_{2} , {p}_{4} )}{{c}_{r} d ( {p}_{1} , {p}_{4} ) - d ( {p}_{2} , {p}_{4} )} \qquad ( 30 )$$

The radii used to calculate c_{γ} correspond to the distance of the landmarks to the rotational center, or in other words, the midpoint of the gripped portion of the X-Y calibration tool that is grasped by the gripper unit. Two concentric circles can be used in the application of the method. Since five circles are detected when using the calibration tool described above, corresponding to the five landmarks on the calibration tool, a total of ten different combinations of circle pairs are possible. Finally, the mathematical mean and the standard deviation of the calculated mid-point are determined based on the ten combinations of circle pairs and compared to programmed limit values. When the midpoint is determined successfully, then the offset between the camera axis and the gripper unit axis can be determined in pixels. As described above, the radii used above correspond to the distance between the landmarks and the gripper unit axis, as measured in pixels. The gripper unit can center the X-Y calibration tool in the field of vision of the camera, the camera can identify the center point of the image and then determine a number of pixels on the X and Y axes from the center point to the closest marker to the center point. Based on the distance from the center point to the closest marker, and the distance from the closest marker to the gripper unit axis, the offset can be calculated in pixels.

In some embodiments, a pixel-to-motor step ratio can be determined to convert the coordinates of the mid-point of the circle from the camera coordinate system in pixels to the motor coordinate system in steps. To do so, the robotic arm can move to the tool recording position saved at the beginning and place the tool back in that position. First, a landmark is centered in the camera image. In some embodiments, this can be a particular landmark on the X-Y calibration tool, such as the middle landmark of the exemplary tool described. However, any landmark can be used. The robot then moves a specified distance (in steps) in the X and Y directions, while at the same time, the camera system records the position of the landmark. These values are then used to calculate the ratio of pixels to steps for both axes. Using the previously determined mid-point of the circle, this ratio can then be used to determine the distance of the gripper axis to the mid-point of the camera image in motor steps.

In accordance with an embodiment, the calibration process described above can be repeated at at least one other gripping height to determine linear offset functions dₓ(z)=mₓz+bₓ or d_{y}(z)=m_{y}z+b_{y}, which describe the correlation between the distance of the optical axis of the camera to the mechanical axis of the gripper robot in directions X and Y with height Z. If the operation is performed for more than two different heights, a linear function can then be fitted using the measured points (d_{x,y}, z). This function corresponds to the tilt of the optical camera axis relative to the mechanical gripper axis over the whole working space.

In another embodiment the distortion correction step can be combined with the X-Y calibration step. As described above, a series of images can be taken by the camera, as the X-Y calibration tool is rotated through the camera view. The tool can include one or more landmarks, such as the circular landmarks shown in FIG. 3 or a periodically repeating pattern landmark, such as a checkerboard. Using the series of images, the system can determine distortion correction parameters, as described above. Subsequently, the distortion correction can be applied to the images. X-Y calibration can then be performed, as described above, using the distortion corrected series of images. The X-Y calibration coefficients can be determined by fitting known points in the landmark to the distortion corrected series of image to determine the circular movement. These specific points can include the center point of a circular landmark, or an edge in a periodically repeating pattern landmark.

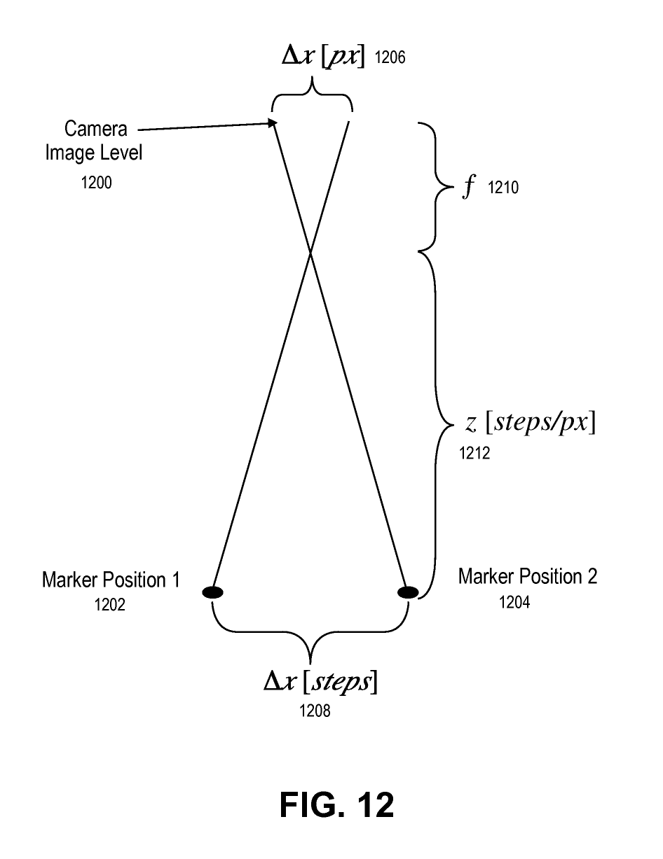

FIG. 12 shows triangulation of a landmark to determine a height of the gripper unit, in accordance with an embodiment of the invention. The Z calibration tool described above and shown in FIG. 4, can be used for this process. First, the robotic arm can move into position over the Z calibration tool and search for the first landmark. In accordance with an embodiment, the first landmark can be uniquely identified by a bar code or other label which can be identified by the camera. The robot then repositions itself such that the landmark is in the center of the image. Once the landmark has been successfully centered, the robot moves a given distance to the left or right of the landmark and records the position. In this example, triangulation can be performed based on parallax, or change in apparent position of the landmark from marker position 1 1202 to marker position 2 1204, at the camera image level 1200. The camera moves a known distance to the left or right of the marker. The distance can be determined in steps, based on the motor position. The change in apparent position of the landmark can be determined by the camera in pixels. As shown in FIG. 12, based on these measurements, triangulation can be used to determine the height of the landmark in steps per pixel:

$$z [ steps / px ] = \frac{f}{Δ x [ px ]} * Δ x [ steps ] \qquad ( 31 )$$

In this case, f corresponds to the focal length. However, since it cannot be clearly determined due to the depth of field range in which the measurement is taken, it can be assumed to be one. Once the height of the landmark has been determined using triangulation, the determined height can be translated into a number of steps in the z axis. To do so, the robotic arm can be positioned directly above the landmark using the X-Y offset determined above. Next, the movement parameters of the z axis are adjusted so that movement is stopped if a pressure sensor in the robotic arm detects a predefined level of resistance. The robot can then be slowly lowered along the z axis until the gripper touches the landmark, at which point the pressure sensor detects resistance and causes the robot to stop. The current position of the gripper in steps is then stored.

In accordance with an embodiment, this process can be repeated at all three steps of the tool. Finally, the three measured points (z[steps/px],z[steps]) are used to fit a linear function. Using the height in pixels that was determined using triangulation, this function can now be used to determine the height in steps for the z axis.

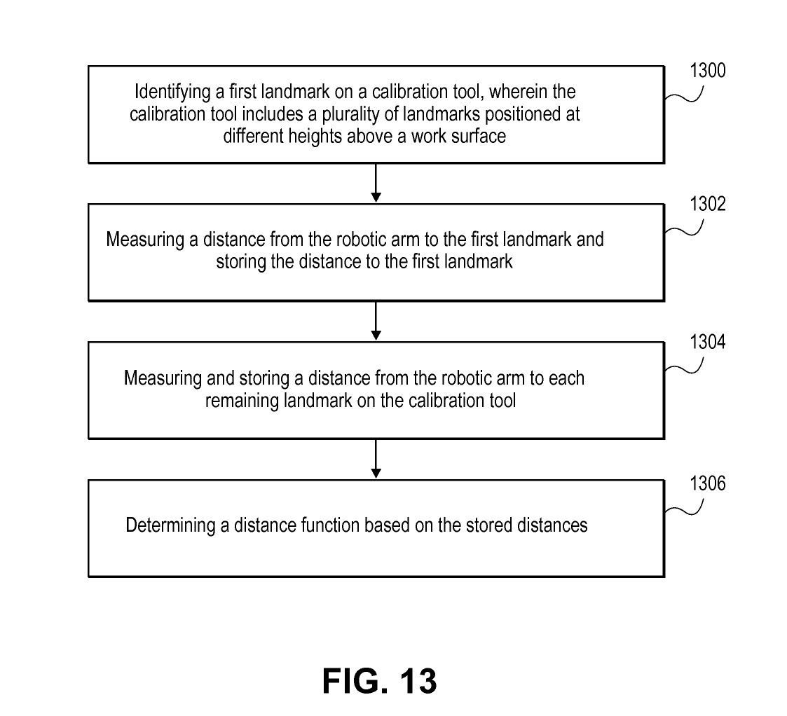

FIG. 13 shows a method of Z calibration, in accordance with an embodiment. At 1300, a first landmark is identified on a Z calibration tool. As described above, the Z calibration tool can include a plurality of landmarks positioned at different heights above a work surface. At 1302, a distance from the robotic arm to the first landmark can be measured and stored. As described above, the distance to the first landmark can be calculated using triangulation to determine a distance in steps per pixel, and a hard touch of the gripper unit, where the gripper unit can be lowered until it makes contact with the landmark can be used to measure a height in steps. At 1304, this measurement is repeated for each remaining landmark on the Z calibration tool. At 1306, each pair of measurements (distance in steps per pixel, and distance in steps) is used to fit a linear distance function. The linear distance function can then be used to convert between the camera coordinate system in pixels and the robot coordinate system in steps, thus calibrating the robotic arm on the Z axis.

In accordance with an embodiment, the distortion correction step can also be combined with the Z calibration step. As described above, to correct for lens distortion, a series of images of a landmark or landmarks can be taken by the camera. A Z calibration tool, such as the one shown in FIG. 4, can be used with one or more periodically repeating pattern landmarks. The landmark can be placed in a plurality of different positions within the field of view of the camera. Using these images, the distortion correction coefficients can be determined and then used to correct the distortion in the series of images.

Using the distortion corrected images, Z calibration can then be performed. Since the geometry of the periodically repeating pattern landmark is known, the system can determine a pixel to distance relationship with the known pattern. For example, a distance between edges in the checkerboard pattern landmark can be stored in memory. Once the images are corrected for distortion, the images can be analyzed to determine a number of pixels between the edges in the landmark, and a pixel to distance relationship can be determined. The robot arm can then be lowered to touch the landmark, as described above. The distance traveled by the robot arm to contact the landmark can be recorded and used to convert the pixel to distance relationship to a pixel to step relationship on the robot reference system. In accordance with an embodiment, the process can be repeated for additional steps on the z calibration tool.

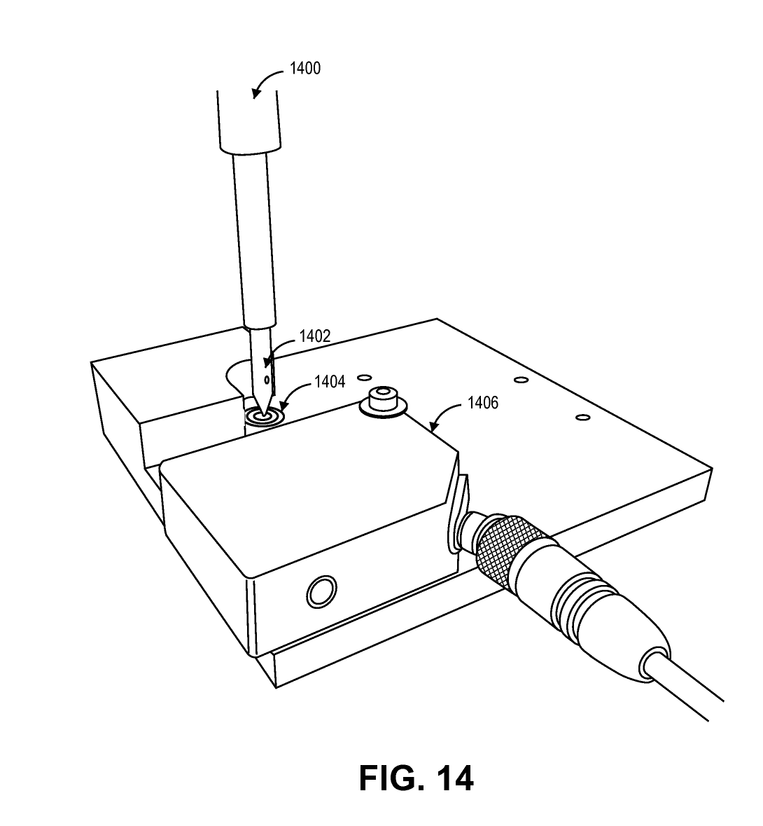

FIG. 14 shows a system for determining precision of a camera-based auto-alignment system, in accordance with an embodiment. As shown in FIG. 14, after the alignment process is complete, a probe 1400 can be gripped by the gripper unit and positioned over a landmark 1404 on the work surface. A laser distance sensor 1406 can be used to determine the distance to the probe tip by targeting the probe with a laser 1402. The landmark used for the precision test can be chosen such that a distance from the mid-point of the landmark to a wall adjacent to the landmark is known. The distance from the laser distance sensor to the probe tip is then measured. The difference between the measured distance and the distance to the back wall is then determined. The laser distance sensor 1406 can then be repositioned by 90° and the process can be repeated. The two measurements result in two points (X₁,Y₁) und (X₂,Y₂) and the known probe tip radius R can then be used to determine the mid-point of the probe tip as follows.

$$\begin{matrix}a = \frac{2 * {Y}_{2} - 2 * {Y}_{1}}{2 * {X}_{2} - 2 * {X}_{1}} & ( 32 ) \\ b = \frac{( {X}_{1}^{2} + {Y}_{1}^{2} - {R}^{2} ) - ( {X}_{2}^{2} + {Y}_{2}^{2} - {R}^{2} )}{2 * {X}_{2} - 2 * {X}_{1}} & ( 33 ) \\ c = \frac{- 2 * a * ( {X}_{1} - b ) - 2 * {Y}_{1}}{{a}^{2} + 1} & ( 34 ) \\ d = \frac{{( {X}_{1} - b )}^{2} + {Y}_{1}^{2} - {R}^{2}}{{a}^{2} + 1} & ( 35 ) \\ {X}_{m 1 , m 2} = - \frac{p}{2} \pm \sqrt{\frac{{p}^{2}}{4} - q} & ( 36 ) \\ {Y}_{m 1 , m 2} = a * {X}_{m 1 , m 2} + b & ( 37 )\end{matrix}$$

However, the two points and the radius do not provide a final solution. As can be seen in formula (26) and (27), there are two possible mid-points for the circle (X_{m1,m2}, Y_{m1,m2}); however, there is typically a large difference between one of the possible midpoints and the measured midpoint of the landmark. Once the correct midpoint has been identified, the midpoint measurements can be compared to determine the precision of the auto-alignment system.

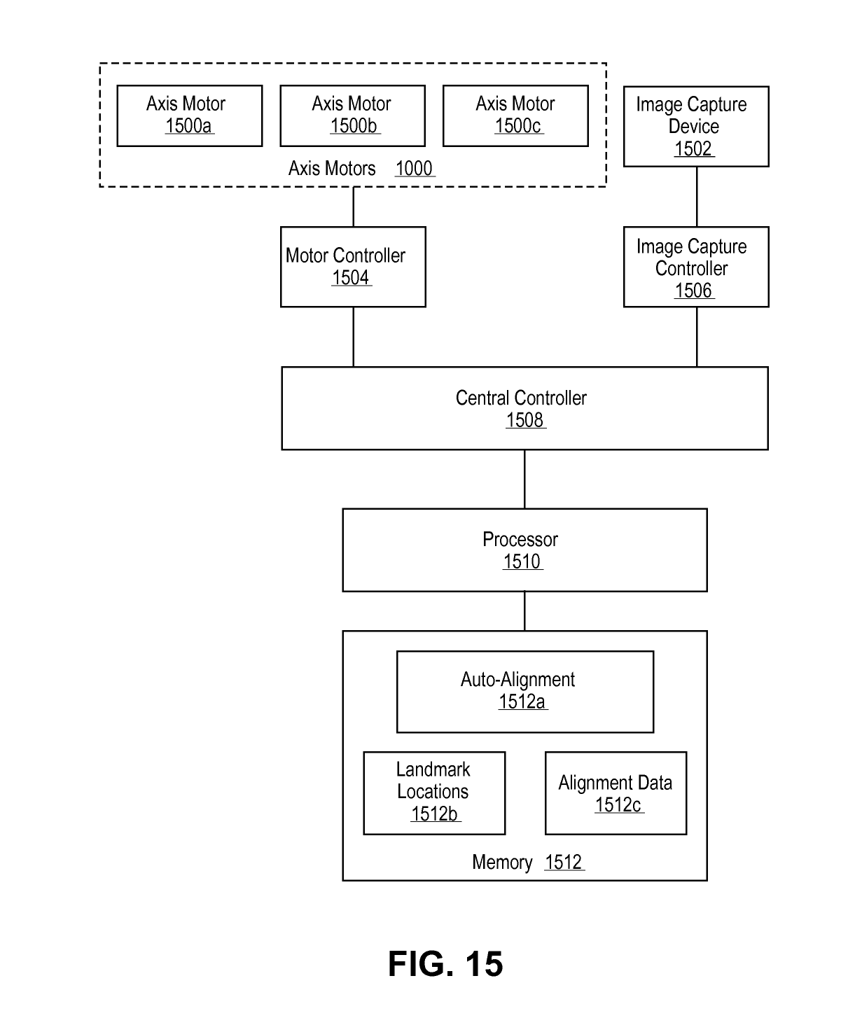

FIG. 15 shows a block diagram of an auto-alignment system, in accordance with an embodiment of the invention. The auto-alignment system can include a plurality of axis motors 1500, including axis motors 1500a, 1500b, and 1500c. The axis motors 1500 can be used to position the robotic arm and gripper unit in three-dimensional space over the work surface. An image capture device 1502, such as a camera, can be coupled to the gripper unit and used to automatically align the robotic arm with the work surface. One or more motor controllers 1504 and an image capture device controller 1506 can relay instructions from a central controller 1508 during the auto-alignment process. In some embodiments, the motor controller 1504 can record position information from each axis motor, such as encoder counts or steps, and the image capture device controller 1506 can instruct the image capture device to take images at regular intervals and pass the captured images to the central controller 1508 for processing. Central controller 1508 can receive alignment instructions from processor 1510 and return alignment results, such as position information and captured images, received from the motor controller and image capture device controller. The processor 1510 can use the information returned from the central controller to determine the offset between the camera axis and the gripper unit axis, triangulate the height of the gripper unit, and determine whether the alignment process is complete. In some embodiments, an image processor can be used to execute image processing operations separately from processor 1510. The processor 1510 can be coupled to a memory 1512 which may comprise an auto-alignment module 1512a that may comprise computer code, executable by the processor 1510 to perform auto-alignment, including instructions to the axis motors to move the robotic arm along in the X-Y plane and instructions to the image capture device to capture images of landmarks on the work surface and analyze the captured images. The memory can further include storage for the determined landmark locations 1512b and alignment data 1512c, including position data for elements on the work surface (drawers, tools, etc.) relative to the landmark location(s).

The processor 1510 may comprise any suitable data processor for processing data. For example, the processor may comprise one or more microprocessors that function separately or together to cause various components of the system to operate.

The memory 1512 may comprise any suitable type of memory device, in any suitable combination. The memory 1512 may comprise one or more volatile or non-volatile memory devices, which operate using any suitable electrical, magnetic, and/or optical data storage technology.

The various participants and elements described herein with reference to the figures may operate one or more computer apparatuses to facilitate the functions described herein. Any of the elements in the above description, including any servers, processors, or databases, may use any suitable number of subsystems to facilitate the functions described herein, such as, e.g., functions for operating and/or controlling the functional units and modules of the laboratory automation system, axis controllers, sensor controllers, etc.

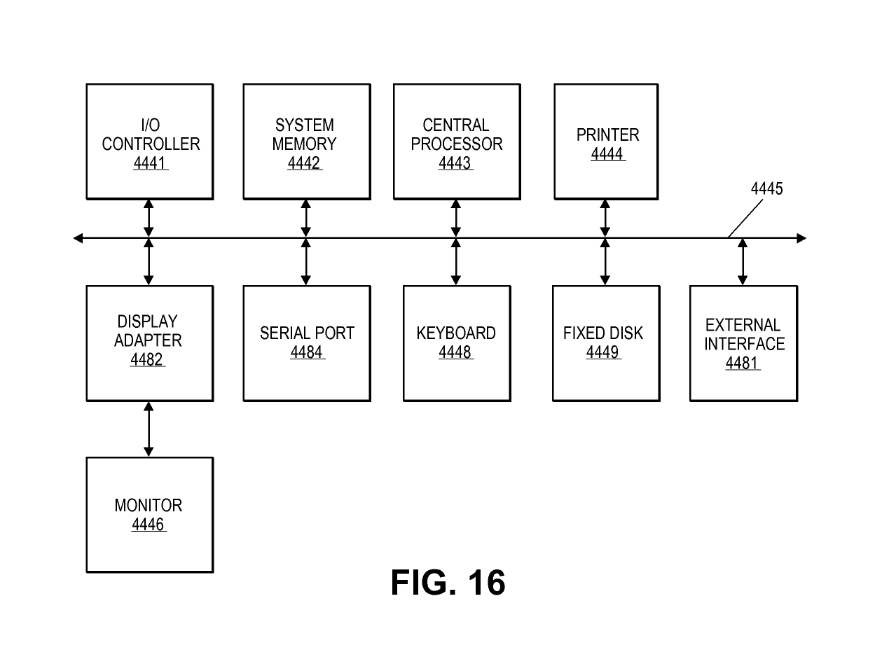

Examples of such subsystems or components are shown in FIG. 16. The subsystems shown in FIG. 16 are interconnected via a system bus 4445. Additional subsystems such as a printer 4444, keyboard 4448, fixed disk 4449 (or other memory comprising computer readable media), monitor 4446, which is coupled to display adapter 4482, and others are shown. Peripherals and input/output (I/O) devices, which couple to I/O controller 4441 (which can be a processor or other suitable controller), can be connected to the computer system by any number of means known in the art, such as serial port 4484. For example, serial port 4484 or external interface 4481 can be used to connect the computer apparatus to a wide area network such as the Internet, a mouse input device, or a scanner. The interconnection via system bus allows the central processor 4443 to communicate with each subsystem and to control the execution of instructions from system memory 4442 or the fixed disk 4449, as well as the exchange of information between subsystems. The system memory 4442 and/or the fixed disk 4449 may embody a computer readable medium.

Embodiments of the technology are not limited to the above-described embodiments. Specific details regarding some of the above-described aspects are provided above. The specific details of the specific aspects may be combined in any suitable manner without departing from the spirit and scope of embodiments of the technology. For example, back end processing, data analysis, data collection, and other processes may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. Furthermore, the present technology may be implemented in the form and/or combination of any image processing. Based on the disclosure and teachings provided herein, a person of ordinary skill in the art will know and appreciate other ways and/or methods to implement the present technology using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for auto-alignment, comprising:
gripping an X-Y calibration tool by a gripper unit of a robotic arm at a first height above a work surface on a first axis;
acquiring images of the X-Y calibration tool at the first height by a camera on a second axis, wherein the camera is coupled to the gripper unit; and
analyzing the images of the first calibration tool at the first height to determine an offset between the second axis and the first axis.

2. The method of claim 1, further comprising:
rotating the X-Y calibration tool through a field of view of the camera, wherein the X-Y calibration tool includes a substantially flat portion including a plurality of landmarks; and
wherein analyzing the images of the X-Y calibration tool comprises
identifying a plurality of elliptical paths, each corresponding to one of the landmarks in the images,
determining a center point of the plurality of elliptical paths corresponding to the first axis,
based on the center point of the plurality of elliptical paths, determining an offset between the first axis and second axis.

3. The method of claim 2, further comprising:
positioning the robotic arm such that the camera is centered over a landmark and recording a first position of the landmark in pixels;
moving the robotic arm a predetermined number of steps in an X direction and a Y direction, and recording a second position of the landmark in pixels;
determining a step to pixel conversion ratio based on a difference between the first position and the second position and the predetermined number of steps.

4. The method of claim 2, further comprising:
gripping the X-Y calibration tool at a second height;
acquiring images of the X-Y calibration tool at the second height by the camera;
analyzing the images of the X-Y calibration tool at the second height to determine a second offset between the second axis and the first axis;
gripping the X-Y calibration tool at a third height;
acquiring images of the X-Y calibration tool at the third height by the camera;
analyzing the images of the X-Y calibration tool at the third height to determine a third offset between the second axis and the first axis; and
determining a linear offset function using the three offsets and three heights.

5. The method of claim 1, wherein at least one landmark on the X-Y calibration tool is a periodically repeating pattern and wherein analyzing the images of the X-Y calibration tool to determine an offset between the second axis and the first axis further comprises:
analyzing the images to determine at least one distortion correction parameter using the periodically repeating pattern, wherein the at least one distortion correction parameter can be used to correct lens-related distortions in the images; and
applying the at least one distortion correction parameter to the images to produce distortion corrected images.

6. The method of claim 1, further comprising:
identifying one or more landmarks on one or more elements on a work surface to align the robotic arm to the work surface.

7. The method of claim 1, wherein the camera is coupled to the gripper unit such that the camera is maintained at a fixed height as the gripper unit moves along a Z axis orthogonal to the work surface.

8. A method for auto-alignment, comprising:
positioning a gripper unit of a robotic arm at a predetermined height above a Z calibration tool, wherein the Z-calibration tool includes a plurality of landmarks on a plurality of levels;
calibrating the gripper unit along a Z-axis over a first landmark on the Z calibration tool, wherein calibrating includes
moving the gripper unit toward the first landmark on the Z calibration tool along the Z-axis until the gripper unit makes contact with the Z calibration tool; and
determining a first number of steps traveled by the gripper unit from the predetermined height to making contact with the Z calibration tool.

9. The method of claim 8, wherein calibrating the gripper unit along a Z-axis over a first landmark further includes:
determining a first height in pixels of the gripper unit over the first landmark on the Z calibration tool using triangulation.

10. The method of claim 8, further comprising:
calibrating the gripper unit along the Z-axis over at least two additional landmarks on the Z calibration tool; and
based on calibration results for each of the landmarks, determining a distance function that converts height in pixels to height in steps.

11. The method of claim 8, wherein at least one landmark on the Z calibration tool is a periodically repeating pattern and wherein calibrating the gripper on a Z-axis using a Z calibration tool further comprises:
analyzing images of the Z calibration tool to determine at least one distortion correction parameter using the periodically repeating pattern, wherein the at least one distortion correction parameter can be used to correct lens-related distortions in the images; and
applying the at least one distortion correction parameter to the images to produce distortion corrected images.

12. A method for auto-alignment, comprising:
gripping a calibration tool by a gripper unit on a first axis;
acquiring images of the calibration tool by a camera on a second axis, wherein the camera is connected to the gripper;
analyzing the images to determine at least one distortion correction parameter, wherein the at least one distortion correction parameter can be used to correct lens-related distortions in the images; and
applying the at least one distortion correction parameter to the images to produce distortion corrected images.

13. The method of claim 12, further comprising:
analyzing the distortion corrected images to determine an offset between the second axis and the first axis using one or more landmarks on a X-Y calibration tool shown in the distortion corrected images.

14. The method of claim 13, further comprising:
calibrating the gripper on a Z-axis using the distortion corrected images using one or more landmarks provided on a Z calibration tool, wherein calibrating the gripper on the Z-axis comprises triangulating landmarks provided on the Z calibration tool.

15. The method of claim 14, wherein calibrating the gripper on a Z-axis further comprises physically calibrating the gripper by moving the gripper toward the Z calibration tool along the Z-axis until the gripper makes contact with the Z calibration tool.

16. An assembly, comprising:
a robotic arm, including a gripper unit, wherein the robotic arm is configured to move in three dimensions over a work surface; and
a camera coupled to the gripper unit such that the camera is maintained at a fixed height as the gripper unit moves along a Z axis substantially orthogonal to the work surface.

17. The assembly of claim 16, further comprising:
an auto-alignment system, including one or more controllers coupled to the robotic arm and camera, wherein the auto-alignment system is configured to instruct the robotic arm to grip an X-Y calibration tool and rotate the X-Y calibration tool through a field of vision of the camera, and wherein the auto-alignment system is configured to instruct the camera to capture images of the X-Y calibration tool as it is rotated; and
wherein the auto-alignment system is further configured to analyze the images of the X-Y calibration tool to determine an offset between a first axis corresponding to the gripper unit and a second axis corresponding to the camera.

18. The assembly of claim 17, wherein the auto-alignment system is further configured to:
identify a plurality of elliptical paths, each corresponding to one of the landmarks in the images,
determine a center point of the plurality of elliptical paths corresponding to the first axis,
based on the center point of the plurality of elliptical paths, determine an offset between the first axis and second axis.

19. The assembly of claim 18, wherein the auto-alignment system is further configured to:
instruct the robotic arm to grip the X-Y calibration tool at a second height;
instruct the camera to acquire images of the X-Y calibration tool at the second height;
analyze the images of the X-Y calibration tool at the second height to determine a second offset between the second axis and the first axis;
instruct the robotic arm to grip the X-Y calibration tool at a third height;
acquiring images of the X-Y calibration tool at the third height by the camera;
instruct the camera to the images of the X-Y calibration tool at the third height to determine a third offset between the second axis and the first axis; and
determine a linear offset function using the three offsets and three heights.

20. The assembly of claim 17, wherein the auto-alignment system is further configured to:
position the robotic arm such that the camera is centered over a landmark and recording a first position of the landmark in pixels;
move the robotic arm a predetermined number of steps in an X direction and a Y direction, and recording a second position of the landmark in pixels;
determine a step to pixel conversion ratio based on a difference between the first position and the second position and the predetermined number of steps.

21. The assembly of claim 17, wherein the auto-alignment system is further configured to:
instruct the camera to capture images of a landmark including a periodically repeating pattern;
analyze the images of the landmark including the periodically repeating pattern to determine at least one distortion correction parameter using the periodically repeating pattern, wherein the at least one distortion correction parameter can be used to correct lens-related distortions in the images; and
apply the at least one distortion correction parameter to the images of the X-Y calibration tool to produce distortion corrected images.

22. The assembly of claim 17, wherein the auto-alignment system is further configured to:
position the gripper unit of the robotic arm at a predetermined height above a Z calibration tool, wherein the Z calibration tool includes a plurality of landmarks on a plurality of levels;
calibrate the gripper unit along a Z-axis over a first landmark on the Z calibration tool, wherein calibrating includes
determining a first height in pixels of the gripper unit over the first landmark on the Z calibration tool using triangulation;
moving the gripper unit toward the first landmark on the Z calibration tool along the Z-axis until the gripper unit makes contact with the Z calibration tool; and
determining a first number of steps traveled by the gripper unit from the predetermined height to making contact with the Z calibration tool.

23. The assembly of claim 22, wherein the auto-alignment system is further configured to:
calibrate the gripper unit along the Z-axis over at least two additional landmarks on the Z calibration tool; and
based on calibration results for each of the landmarks, determine a distance function that converts height in pixels to height in steps.
